(19) United States
(12) Patent Application Publication
(10) Pub. No.: US 2025/0007286 A1
(43) Pub. Date: Jan. 2, 2025

(54) POWER SOURCE DEVICE, POWER SOURCE DEVICE CONTROL METHOD, AND STORAGE MEDIUM

(71) Applicant: HONDA MOTOR CO., LTD., Tokyo (JP)

(72) Inventors: Yuki Kurisu, Wako-shi, Saitama-ken (JP); Tomoya Yamagishi, Wako-shi, Saitama-ken (JP); Makoto Ogawa, Wako-shi, Saitama-ken (JP)

(21) Appl. No.: 18/711,141

(22) PCT Filed: Nov. 17, 2022
(86) PCT No.: PCT/JP2022/042707

§ 371 Date: May 17, 2024

(30) Foreign Application Priority Data
Nov. 19, 2021 (JP) 2021-188295

(51) Int. Cl. H02J 3/06; H02J 3/14; H02J 3/32; H02J 3/46; H02M 7/48

(52) U.S. Cl. CPC H02J 3/06; H02J 3/14; H02J 3/32; H02J 3/46; H02M 7/48

(57) ABSTRACT

A power source device and a control method therefor execute control in which, when an interrupter switches from a blocked state to a connected state, a first state amount, which correlates to the frequency of A/C voltage out-put to the interrupter, from each of a first converter and a second converter match each other, and a second state amount correlating to the phase of the A/C voltage therefrom match each other.

### TECHNICAL FIELD

The present invention relates to an electrical power source device (power source device), a method of controlling an electrical power source device (a power source device control method), a program, and a storage medium.

### BACKGROUND ART

In WO 2021/049622 A1, an electrical power source device in which a plurality of electrical power storage units can be accommodated is disclosed. The electrical power source device is capable of charging the plurality of electrical power storage units with electrical power supplied from an external electrical power source. Further, the electrical power source device is capable of supplying the electrical power from the plurality of electrical power storage units to an external operating unit.

### SUMMARY OF THE INVENTION

The electrical power source device outputs, to the operating unit, the electrical power supplied from the electrical power source, at the time when electrical power is incapable of being supplied to the operating unit from the plurality of electrical power storage units. Further, at the time when the electrical power supplied from the electrical power source is incapable of being output to the operating unit, the electrical power source device outputs, to the operating unit, the electrical power from the plurality of electrical power storage units. In this manner, when the source that supplies the electrical power to the operating unit is switched, the electrical power supplied to the operating unit may undergo a change prior to and after switching takes place.

The present invention has the object of solving the aforementioned problem.

A first aspect of the present invention is characterized by an electrical power source device equipped with an electrical power storage unit, an external connection unit connected to an operating unit provided externally, and a connection/disconnection unit arranged on an electrical power transmission pathway located between the electrical power storage unit and the external connection unit, wherein the electrical power storage unit includes a first electrical power storage unit and a second electrical power storage unit that are arranged in parallel with each other, the electrical power source device comprises a first electrical power conversion unit disposed in the electrical power transmission pathway located between the first electrical power storage unit and the connection/disconnection unit, a second electrical power conversion unit disposed in the electrical power transmission pathway located between the second electrical power storage unit and the connection/disconnection unit, and a control unit configured to control the first electrical power conversion unit and the second electrical power conversion unit, the first electrical power conversion unit converts a direct current electrical power supplied from the first electrical power storage unit into an alternating current electrical power, the second electrical power conversion unit converts a direct current electrical power supplied from the second electrical power storage unit into an alternating current electrical power, and at a time when the connection/disconnection unit switches from a disconnected state to a connected state, the control unit controls the first electrical power conversion unit and the second electrical power conversion unit to perform a control so that first state quantities correlated with frequencies of alternating current voltages output from the first electrical power conversion unit and the second electrical power conversion unit are made to coincide with each other, and further, second state quantities correlated with phases of the alternating current voltages are made to coincide with each other.

A second aspect of the present invention is characterized by a method of controlling an electrical power source device equipped with an electrical power storage unit, an external connection unit connected to an operating unit provided externally, and a connection/disconnection unit arranged on an electrical power transmission pathway located between the electrical power storage unit and the external connection unit, wherein the electrical power storage unit includes a first electrical power storage unit and a second electrical power storage unit that are arranged in parallel with each other, the electrical power source device comprises a first electrical power conversion unit disposed in the electrical power transmission pathway located between the first electrical power storage unit and the connection/disconnection unit, and a second electrical power conversion unit disposed in the electrical power transmission pathway located between the second electrical power storage unit and the connection/disconnection unit, the first electrical power conversion unit converts a direct current electrical power supplied from the first electrical power storage unit into an alternating current electrical power, and the second electrical power conversion unit converts a direct current electrical power supplied from the second electrical power storage unit into an alternating current electrical power, the method of controlling comprising a first step of determining or acquiring switching of the connection/disconnection unit from a disconnected state to a connected state, a second step of performing a control so that first state quantities correlated with frequencies of alternating current voltages output from the first electrical power conversion unit and the second electrical power conversion unit are made to coincide with each other, and further, second state quantities correlated with phases of the alternating current voltages are made to coincide with each other, a third step of switching the connection/disconnection unit from the disconnected state to the connected state, and a fourth step of starting to supply the alternating current electrical power from each of the first electrical power conversion unit and the second electrical power conversion unit to the operating unit.

A third aspect of the present invention is characterized by a program that causes a computer to execute the method of controlling the electrical power source device according to the second aspect.

A fourth aspect of the present invention is characterized by a storage medium configured to store the program according to the third aspect.

According to the present invention, when the source that supplies the electrical power to the operating unit is switched, prior to and after switching taking place, a change in the electrical power supplied to the operating unit can be suppressed.

### BRIEF DESCRIPTION OF DRAWINGS

FIG. 1 is a configuration diagram of an electrical power source device according to a first embodiment;

FIG. 2 is a diagram showing an internal configuration of a first electrical power source device shown in FIG. 1;

FIG. 3 is a diagram showing an internal configuration of a second electrical power source device shown in FIG. 1;

FIG. 4 is a flowchart showing operations of the first embodiment;

FIG. 5 is a timing chart showing an example of a synchronous control;

FIG. 6 is a configuration diagram of an electrical power source device according to a second embodiment; and

FIG. 7 is a diagram showing an internal configuration of the electrical power source device shown in FIG. 6.

### DETAILED DESCRIPTION OF THE INVENTION

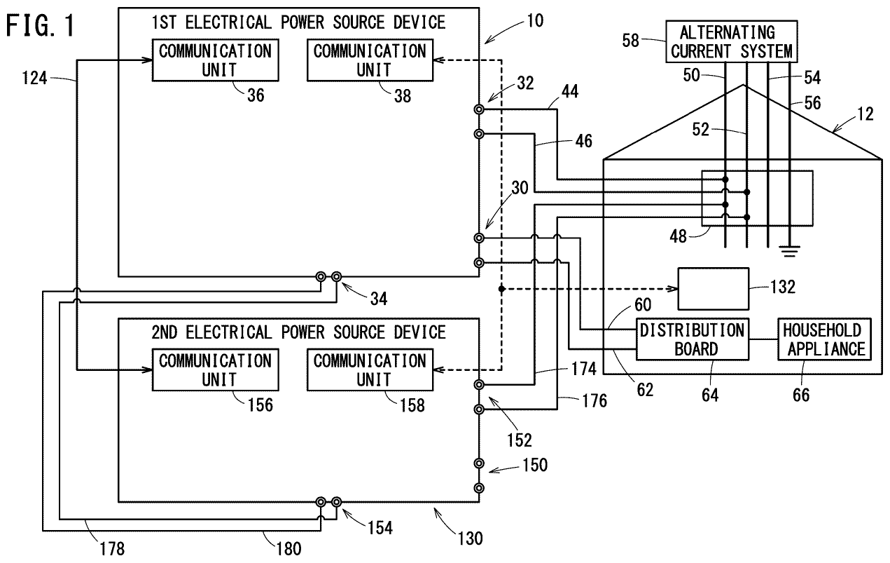

FIG. 1 is a configuration diagram of an electrical power source device 10 according to a first embodiment. In the description that follows, the electrical power source device 10 will be referred to as a first electrical power source device 10.

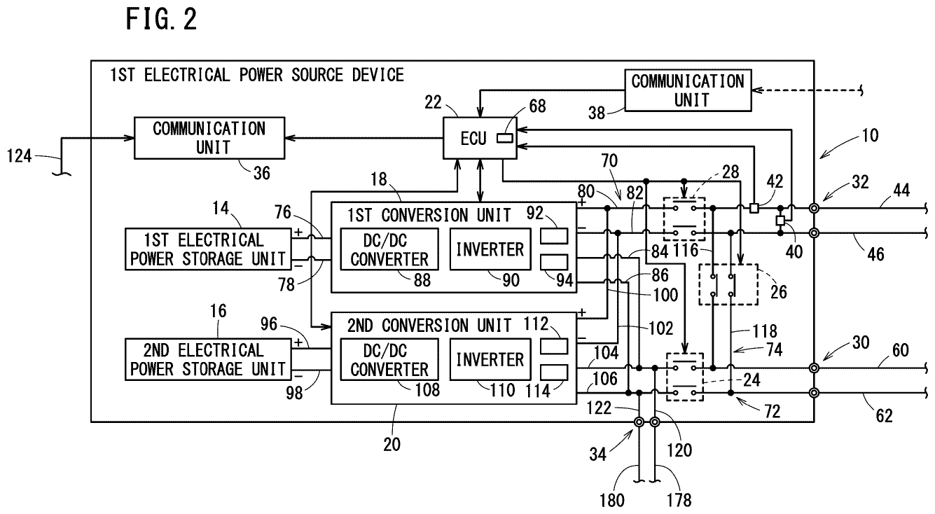

The first electrical power source device 10 is a stationary electrical power source device that is installed in a residential dwelling 12 or the like. As shown in FIG. 2, the first electrical power source device 10 is equipped with a first electrical power storage unit 14, a second electrical power storage unit 16, a first conversion unit 18, a second conversion unit 20, an ECU 22 (an Electronic Control Unit), three connection/disconnection units 24, 26, and 28, three external connection units 30, 32, and 34, two communication units 36 and 38, a voltage sensor 40 (a first electrical power acquisition unit), and an electrical current sensor 42 (the first electrical power acquisition unit).

The first electrical power storage unit 14 and the second electrical power storage unit 16 are DC electrical power sources. The first electrical power storage unit 14 and the second electrical power storage unit 16 are capable of being attached to and detached from the first electrical power source device 10. More specifically, the first electrical power storage unit 14 and the second electrical power storage unit 16 are mobile batteries that are capable of being attached to and detached from the first electrical power source device 10. The first electrical power storage unit 14 and the second electrical power storage unit 16, for example, are preferably battery packs of attachable and detachable lithium ion batteries. Further, it is more preferable for the first electrical power storage unit 14 and the second electrical power storage unit 16 to be capable of being attached to and detached from the first electrical power source device 10 without using a separate working tool or the like. In other words, the first electrical power storage unit 14 and the second electrical power storage unit 16 are configured to be capable of being attached to and detached from the first electrical power source device 10 even without using a working tool or the like. Moreover, it should be noted that at least one of the first electrical power storage unit 14 or the second electrical power storage unit 16 may be fixed to the first electrical power source device 10. Furthermore, in the term “attached to and detached from the first electrical power source device 10,” there are included a case in which the first electrical power storage unit 14 and the second electrical power storage unit 16 are attached to the first electrical power source device 10, and a case in which the first electrical power storage unit 14 and the second electrical power storage unit 16 are removed from the first electrical power source device 10.

The external connection unit 32 (a second external connection unit) is an AC inlet. The external connection unit 32 is electrically connected via two wires 44 and 46 to a distribution board 48 of the residential dwelling 12 (refer to FIG. 1). The distribution board 48 is electrically connected, via four wires 50, 52, 54, and 56, to an external alternating current system 58 (an AC electrical power source) which is a commercial power source. Among the four wires 50, 52, 54, and 56, two wires 50 and 54 are high potential wires. Among the four wires 50, 52, 54, and 56, one wire 52 is a neutral wire. Among the four wires 50, 52, 54, and 56, the remaining one wire 56 is a ground wire. Accordingly, the alternating current system 58 supplies a three-phase AC electrical power (an AC voltage) to the distribution board 48 via the four wires 50, 52, 54, and 56. Moreover, it should be noted that, in the present embodiment, the alternating current system 58 may supply an AC electrical power other than a three-phase AC electrical power to the distribution board 48. The alternating current system 58, for example, may supply a single-phase AC electrical power to the distribution board 48.

The wire 44, which is one of the wires extending from the external connection unit 32, is a positive electrode wire. The one wire 44 is electrically connected to the high potential wire 50. The wire 46, which is another of the wires extending from the external connection unit 32, is a negative electrode wire. The other wire 46 is electrically connected to the neutral wire 52. Accordingly, the distribution board 48 supplies one phase of the AC electrical power (an input electrical power, an external AC electrical power) to the first electrical power source device 10 via the two wires 44 and 46.

The external connection unit 30 (a first external connection unit, a third external connection unit) is an AC outlet. The external connection unit 30 is electrically connected via two wires 60 and 62 to another distribution board 64 of the residential dwelling 12. The other distribution board 64 is electrically connected to a household appliance 66 (an operating unit) which serves as a load. The first electrical power source device 10 is capable of supplying an AC electrical power (an output electrical power) to the household appliance 66 via the two wires 60 and 62 and the distribution board 64. Moreover, the household appliance 66 is an electrical power operating unit that operates by the AC electrical power being supplied thereto.

The ECU 22 (a first control unit to a tenth control unit, the first electrical power acquisition unit, a second electrical power acquisition unit) is a computer that controls each unit of the first electrical power source device 10 in an integrated manner. The ECU 22, by reading out and executing programs stored in a memory 68 (a storage medium), realizes various functions.

The first electrical power storage unit 14 and the second electrical power storage unit 16, and the external connection unit 32, are electrically connected via a connection path 70 (a second connection path). The first electrical power storage unit 14 and the second electrical power storage unit 16, and the external connection unit 30, are electrically connected via an electrical power transmission pathway 72. The two external connection units 30 and 32 are electrically connected via a connection path 74 (a first connection path).

Specifically, the first electrical power storage unit 14 is electrically connected via two wires 76 and 78 to an input side of the first conversion unit 18. An output side of the first conversion unit 18 is electrically connected via two wires 80 and 82 to the external connection unit 32. The connection/disconnection unit 28 (a fourth connection/disconnection unit) is arranged on the two wires 80 and 82. The output side of the first conversion unit 18 is electrically connected via another two wires 84 and 86 to the external connection unit 30. The connection/disconnection unit 24 (a first connection/disconnection unit, a third connection/disconnection unit) is arranged on the other two wires 84 and 86.

The first conversion unit 18 includes a DC/DC converter 88, an inverter 90, a voltage sensor 92 (the second electrical power acquisition unit), and an electrical current sensor 94 (the second electrical power acquisition unit).

The DC/DC converter 88, based on a control signal from the ECU 22, converts the DC voltage of the first electrical power storage unit 14 into a DC voltage of a desired value. The inverter 90, based on a control signal from the ECU 22, converts the DC voltage converted by the DC/DC converter 88 into an AC voltage. Alternatively, the inverter 90, based on a control signal from the ECU 22, converts the AC voltage (an external AC voltage) supplied from the external connection unit 32 into a DC voltage. Moreover, the AC voltage supplied from the external connection unit 32 is an AC voltage supplied from the distribution board 48 to the first electrical power source device 10. Accordingly, the first conversion unit 18 converts the DC electrical power supplied from the first electrical power storage unit 14 into an AC electrical power, or alternatively, converts the AC electrical power supplied from the distribution board 48 into a DC electrical power.

The voltage sensor 92 sequentially detects the AC voltage on the output side of the first conversion unit 18 (an output side of the inverter 90), and outputs the detection result to the ECU 22. The electrical current sensor 94 sequentially detects the AC electrical current flowing to the output side of the first conversion unit 18, and outputs the detection result to the ECU 22.

The second electrical power storage unit 16 is electrically connected via two wires 96 and 98 to an input side of the second conversion unit 20. Two wires 100 and 102 extend from an output side of the second conversion unit 20. The two wires 100 and 102 are electrically connected to the two wires 80 and 82 that extend from the output side of the first conversion unit 18. The two wires 100 and 102 are electrically connected, respectively, to locations in the two wires 80 and 82 between the first conversion unit 18 and the connection/disconnection unit 28. Accordingly, the first electrical power storage unit 14 and the second electrical power storage unit 16 are arranged mutually in parallel with respect to the connection/disconnection unit 28.

Another two wires 104 and 106 extend from the output side of the second conversion unit 20. The other two wires 104 and 106 are electrically connected to the other two wires 84 and 86 that extend from the output side of the first conversion unit 18. The other two wires 104 and 106 are electrically connected, respectively, to locations in the other two wires 84 and 86 between the first conversion unit 18 and the connection/disconnection unit 24. Accordingly, the first electrical power storage unit 14 and the second electrical power storage unit 16 are arranged mutually in parallel with respect to the connection/disconnection unit 24.

The second conversion unit 20, similar to the first conversion unit 18, includes a DC/DC converter 108, an inverter 110, a voltage sensor 112 (the second electrical power acquisition unit), and an electrical current sensor 114 (the second electrical power acquisition unit).

The DC/DC converter 108, based on a control signal from the ECU 22, converts the DC voltage of the second electrical power storage unit 16 into a DC voltage of a desired value. The inverter 110, based on a control signal from the ECU 22, converts the DC voltage after conversion thereof into an AC voltage, or alternatively, converts the AC voltage into a DC voltage. Accordingly, the second conversion unit 20 converts the DC electrical power supplied from the second electrical power storage unit 16 into an AC electrical power, or alternatively, converts the AC electrical power supplied from the distribution board 48 into a DC electrical power.

The voltage sensor 112 sequentially detects the AC voltage on the output side of the second conversion unit 20 (an output side of the inverter 110), and outputs the detection result to the ECU 22. The electrical current sensor 114 sequentially detects the AC electrical current flowing to the output side of the second conversion unit 20, and outputs the detection result to the ECU 22.

The two wires 80 and 82 that are electrically connected to the external connection unit 32, and the two wires 84 and 86 that are electrically connected to the external connection unit 30 are electrically connected via another two wires 116 and 118. The other two wires 116 and 118 electrically connect locations in the two wires 80 and 82 between the connection/disconnection unit 28 and the external connection unit 32, to locations in the two wires 84 and 86 between the connection/disconnection unit 24 and the external connection unit 30. The connection/disconnection unit 26 (a second connection/disconnection unit) is arranged on the two wires 116 and 118.

Accordingly, the connection path 70 is constituted by the plurality of wires 76, 78, 80, 82, 96, 98, 100, and 102 located between the first electrical power storage unit 14 and the second electrical power storage unit 16 and the external connection unit 32. In this case, the first electrical power storage unit 14 and the first conversion unit 18 are arranged in series on the connection path 70. Further, the second electrical power storage unit 16 and the second conversion unit 20 are arranged in series on the connection path 70. Moreover, the term “arranged in series” implies that these units are arranged in order on the connection path 70.

The electrical power transmission pathway 72 is constituted by the plurality of wires 76, 78, 84, 86, 96, 98, 104, and 106 located between the first electrical power storage unit 14 and the second electrical power storage unit 16 and the external connection unit 30. In this case, the first electrical power storage unit 14 and the first conversion unit 18 are arranged in series on the electrical power transmission pathway 72. Further, the second electrical power storage unit 16 and the second conversion unit 20 are arranged in series on the electrical power transmission pathway 72. Moreover, the term “arranged in series” implies that these units are arranged in order on the electrical power transmission pathway 72.

The connection path 74 is constituted by the plurality of wires 116 and 118 located between the two external connection units 30 and 32.

The three connection/disconnection units 24, 26, and 28 are switching units such as semiconductor switches, relays, and contactors or the like. The three connection/disconnection units 24, 26, and 28, based on a control signal from the ECU 22, are switched to a connected state or a disconnected state. In should be noted that the connected state is an ON state in which the connection/disconnection units 24, 26, and 28 are turned ON, and both ends of the connection/disconnection units 24, 26, and 28 are electrically conductive. The disconnected state is an OFF state in which the connection/disconnection units 24, 26, and 28 are turned OFF, and both ends of the connection/disconnection units 24, 26, and 28 are electrically non-conductive.

The electrical current sensor 42 is disposed at a location in the positive electrode wire 80 between the connection/disconnection unit 28 and the external connection unit 32. The electrical current sensor 42 sequentially detects the AC electrical current flowing from the distribution board 48 to the first electrical power source device 10, and outputs the detection result to the ECU 22.

The voltage sensor 40 is disposed at a location between the two wires 80 and 82 between the connection/disconnection unit 28 and the external connection unit 32. The voltage sensor 40 sequentially detects the AC voltage supplied from the distribution board 48 to the first electrical power source device 10, and outputs the detection result to the ECU 22.

The ECU 22, based on the AC voltage detected by the voltage sensor 40 and the AC electrical current detected by the electrical current sensor 42, calculates the AC electrical power supplied from the distribution board 48 to the first electrical power source device 10. The ECU 22, based on the AC voltage detected by the voltage sensor 92 and the AC electrical current detected by the electrical current sensor 94, calculates the AC electrical power output from the first conversion unit 18, or alternatively, the AC electrical power input to the first conversion unit 18. The ECU 22, based on the AC voltage detected by the voltage sensor 112 and the AC electrical current detected by the electrical current sensor 114, calculates the AC electrical power output from the second conversion unit 20, or alternatively, the AC electrical power input to the second conversion unit 20. Each of the AC electrical powers calculated by the ECU 22 may be an apparent electrical power or may be an effective electrical power.

The external connection unit 34 (a fourth external connection unit) is electrically connected, via two wires 120 and 122, to the two wires 84 and 86 located between the first conversion unit 18 and the connection/disconnection unit 24. Specifically, the two wires 120 and 122 are connected to locations in the two wires 84 and 86, between connection locations with the other two wires 104 and 106 that extends from the second conversion unit 20, and the connection/disconnection unit 24.

The communication unit 36, based on a control from the ECU 22, carries out transmission and reception of signals or information to and from a second electrical power source device 130 (another electrical power source device), via a communication line 124 such as a CAN (a Controller Area Network) or the like. The other communication unit 38, based on a control from the ECU 22, carries out transmission and reception of signals or information by way of wireless communication between an integrated electrical power source manager 132 of the residential dwelling 12 and the second electrical power source device 130. The integrated electrical power source manager 132 manages the amount of electrical power generated by an electrical power generating device (not shown) installed in the residential dwelling 12, and an amount of electricity (electrical power) stored in the first electrical power storage unit 14 and the second electrical power storage unit 16, thereby controlling the amount of electrical power supplied to the residential dwelling 12 from the alternating current system 58.

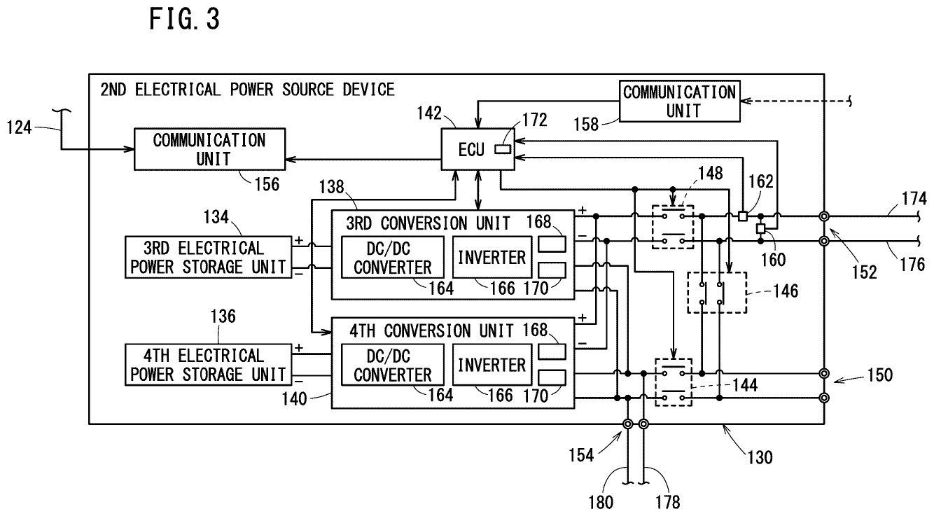

As shown in FIG. 3, the second electrical power source device 130 has the same configuration as the first electrical power source device 10 (refer to FIG. 2). More specifically, the second electrical power source device 130 is a stationary electrical power source device that is installed in the residential dwelling 12 (refer to FIG. 1) or the like. The second electrical power source device 130 is equipped with a third electrical power storage unit 134 (another electrical power storage unit), a fourth electrical power storage unit 136 (another electrical power storage unit), a third conversion unit 138, a fourth conversion unit 140, an ECU 142 (another control unit), three connection/disconnection units 144, 146, and 148, three external connection units 150, 152, and 154, two communication units 156 and 158, a voltage sensor 160, and an electrical current sensor 162. Each of the third conversion unit 138 and the fourth conversion unit 140 includes a DC/DC converter 164, an inverter 166, a voltage sensor 168, and an electrical current sensor 170. The ECU 142 includes a memory 172. Accordingly, concerning the details of the internal configuration of the second electrical power source device 130, description thereof will be omitted.

Moreover, the external connection unit 152 of the second electrical power source device 130, and the distribution board 48 are electrically connected via two wires 174 and 176. The external connection unit 154 of the second electrical power source device 130, and the external connection unit 34 of the first electrical power source device 10 are electrically connected via two wires 178 and 180. The communication unit 156 is capable of transmitting and receiving signals or information to and from the communication unit 36 of the first electrical power source device 10 via the communication line 124. The communication unit 158 is capable of transmitting and receiving signals or information by way of wireless communication between the communication unit 38 of the first electrical power source device 10 and the integrated electrical power source manager 132.

Further, in the first embodiment, the second electrical power source device 130 need only include at least the third electrical power storage unit 134, the fourth electrical power storage unit 136, the third conversion unit 138, the fourth conversion unit 140, and the ECU 142.

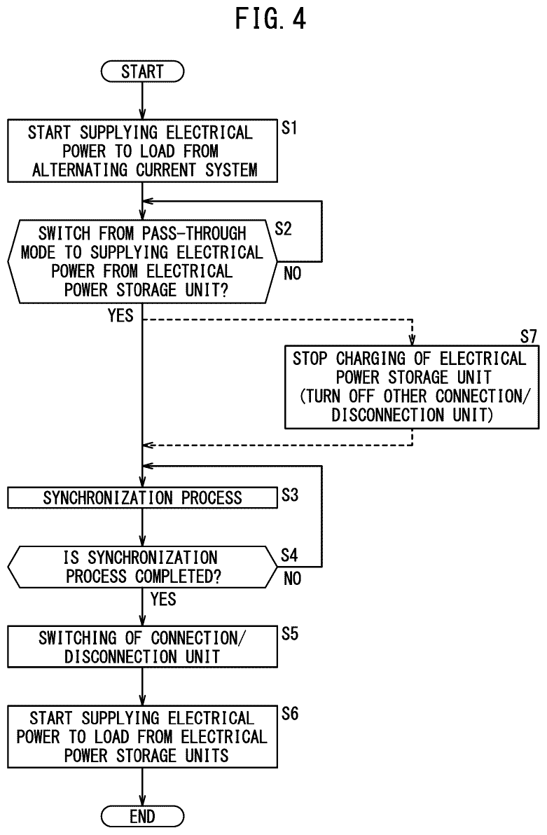

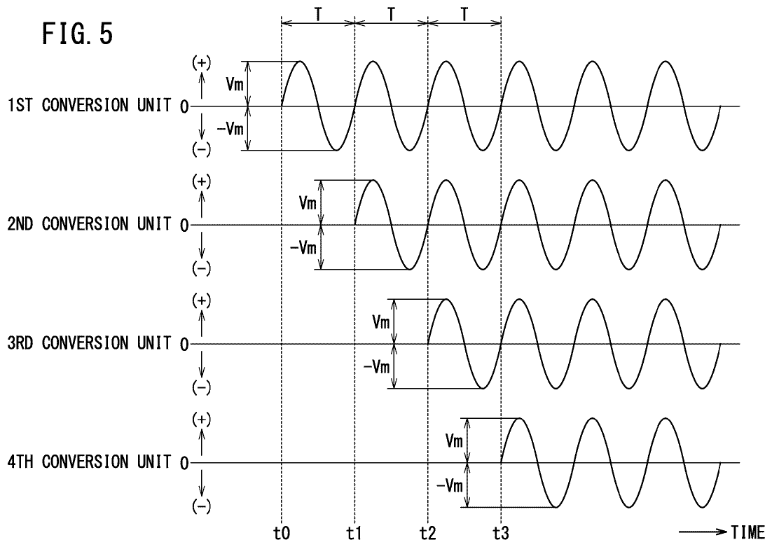

Concerning the operations of the first electrical power source device 10 which is configured as described above, a description thereof will be presented with reference to FIG. 4 and FIG. 5. In the description of such operations, as necessary, descriptions will be given also with reference to FIG. 1 to FIG. 3. In this instance, a description will be given of a case in which, at a time when the AC electrical power that is supplied to the first electrical power source device 10 from the distribution board 48 is being supplied to the household appliance 66, switching is made to the supply of the electrical power to the household appliance 66 from the first electrical power storage unit 14 and the second electrical power storage unit 16 by controlling the connection/disconnection units 24, 26, and 28.

At first, in step S1 of FIG. 4, the alternating current system 58 (refer to FIG. 1) supplies the three-phase AC electrical power to the distribution board 48. The distribution board 48 supplies one phase of the AC electrical power to the first electrical power source device 10. The ECU 22 (refer to FIG. 2) of the first electrical power source device 10 places one connection/disconnection unit 26 in a connected state (an ON state), and further, places the two connection/disconnection units 24 and 28 in a disconnected state (an OFF state). Consequently, the AC electrical power input to the external connection unit 32 is supplied to the household appliance 66 via the connection path 74, the external connection unit 30, and the other distribution board 64. More specifically, a pass-through mode is initiated in which the AC electrical power supplied from the distribution board 48 is directly supplied to the household appliance 66.

In this case, each of the three voltage sensors 40, 92, and 112 sequentially detects the AC voltage, and outputs the detection result to the ECU 22. Each of the three electrical current sensors 42, 94, and 114 sequentially detects the AC electrical current, and outputs the detection result to the ECU 22. The ECU 22, based on the detection results of the voltage sensor 40 and the electrical current sensor 42, sequentially calculates the AC electrical power input from the distribution board 48 to the external connection unit 30. Further, the ECU 22, based on the detection results of the voltage sensors 92 and 112 and the electrical current sensors 94 and 114, sequentially calculates the AC electrical power on the output sides of the first conversion unit 18 and the second conversion unit 20.

Moreover, as noted previously, since the two connection/disconnection units 24 and 28 are in the disconnected state, charging is not carried out on the first electrical power storage unit 14 and the second electrical power storage unit 16, or alternatively, outputting of the electrical power from the first electrical power storage unit 14 and the second electrical power storage unit 16 is not carried out.

In next step S2, the ECU 22 determines whether or not to switch from the pass-through mode to supplying the electrical power to the household appliance 66 from the first electrical power storage unit 14 and the second electrical power storage unit 16. In the case it is determined to perform switching of the supply of the electrical power (step S2: YES), the ECU 22 proceeds to the process of step S3.

Specifically, for example, in the following cases (1) to (3), the ECU 22 determines to switch to supplying the electrical power to the household appliance 66 from the first electrical power storage unit 14 and the second electrical power storage unit 16. It should be noted that the following cases (1) and (2) below are events that the ECU 22 is capable of predicting. Further, the following case (3) is a sudden event that the ECU 22 is incapable of predicting.

Case (1) is a case for the time period in which the electricity charge for the AC electrical power supplied from the alternating current system 58 becomes high. In this case, in order to reduce the electricity charge, the ECU 22 determines to switch to supplying the electrical power from the first electrical power storage unit 14 and the second electrical power storage unit 16. Further, concerning the electricity charge, a rate plan of the electrical power company with which the residential dwelling 12 is contracted may be stored beforehand in the memory 68. Consequently, by referring to the rate plan, the ECU 22 can grasp a time period in which the electricity charge becomes high.

Case (2) is a case in which it is acquired that the AC electrical power supplied from the distribution board 48 has become smaller than the AC electrical power supplied to the household appliance 66. Alternatively, it is a case in which it is acquired that the AC electrical power supplied from the distribution board 48 will become smaller than the AC electrical power supplied to the household appliance 66. In greater detail, this is a case in which it is acquired that a requested value of the AC electrical power requested by the household appliance 66 becomes larger than the AC electrical power supplied from the distribution board 48 due to a load fluctuation or the like. This requested value is transmitted via wireless communication from the integrated electrical power source manager 132 to the communication unit 38 of the first electrical power source device 10. The ECU 22 sequentially calculates the AC electrical power supplied from the distribution board 48 to the first electrical power source device 10. The ECU 22 compares the calculated AC electrical power with the requested value, and determines whether the requested value is larger than the AC electrical power. In the case it is determined (acquired) that the requested value is larger than the calculated AC electrical power, then in order to eliminate an insufficiency in the electrical power supplied to the household appliance 66, the ECU 22 determines to switch to supplying the electrical power from the first electrical power storage unit 14 and the second electrical power storage unit 16.

Case (3) is a case in which the supply of the AC electrical power from the distribution board 48 to the first electrical power source device 10 is stopped due to an instability, a power outage, or a disconnection or the like of the alternating current system 58. In this case, the value of the AC voltage detected by the voltage sensor 40 and the value of the AC electrical current detected by the electrical current sensor 42 become approximately a zero level. Accordingly, in order to avoid an interruption of the electrical power supply to the household appliance 66, the ECU 22 determines to switch to supplying the electrical power from the first electrical power storage unit 14 and the second electrical power storage unit 16.

In step S3, the ECU 22, by controlling the first conversion unit 18 and the second conversion unit 20, performs a synchronization process to cause the AC voltage output from the inverter 90, the AC voltage output from the inverter 110, and the AC voltage supplied to the first electrical power source device 10 from the distribution board 48 to be synchronized.

Specifically, in the synchronization process, a control is performed so that first state quantities correlated with the frequencies of the two AC voltages output from the inverters 90 and 110 are made to coincide. Further, in the synchronization process, a control is performed so that second state quantities correlated with the phases of the two AC voltages output from the inverters 90 and 110 are made to coincide. Furthermore, in the synchronization process, a control is performed so that third state quantities correlated with the amplitudes of the two AC voltages output from the inverters 90 and 110 are made to coincide. Further still, in the synchronization process, a control is performed so that a fourth state quantity correlated with the frequency of the AC voltage supplied from the distribution board 48 to the first electrical power source device 10, and the first state quantities are made to coincide. Further, in the synchronization process, a control is performed so that a fifth state quantity correlated with the phase of the AC voltage supplied from the distribution board 48 to the first electrical power source device 10, and the second state quantities are made to coincide.

The first state quantities are physical quantities related to the frequencies of the two AC voltages output from the inverters 90 and 110. Specifically, the first state quantities are periods or wavelengths of the two AC voltages. The frequencies of the two AC voltages may be the first state quantities. The second state quantities are physical quantities related to the phases of the two AC voltages. The phases of the two AC voltages may be the second state quantities. The third state quantities are physical quantities related to the amplitudes of the two AC voltages. Specifically, the third state quantities refer to the magnitudes of the two AC voltages at a predetermined phase. The amplitudes of the two AC voltages may be the third state quantities.

The fourth state quantity is a physical quantity related to the frequency of the AC voltage supplied from the distribution board 48 to the first electrical power source device 10. Specifically, the fourth state quantity is a period or a wavelength of the AC voltage. The frequency of the AC voltage may be the fourth state quantity. The fifth state quantity is a physical quantity related to the phase of the AC voltage supplied from the distribution board 48 to the first electrical power source device 10. The phase of the AC voltage may be the fifth state quantity.

Moreover, in step S3, the two connection/disconnection units 24 and 28 are in a disconnected state. Consequently, during the synchronization process, it is possible to avoid erroneously supplying, to the household appliance 66, the two AC voltages output from the inverters 90 and 110.

Further, in step S3, in accordance with the requested value from the household appliance 66, the ECU 22 may adjust the amplitudes of the two AC voltages output from the inverters 90 and 110. Consequently, in step S6, which will be discussed later, the AC electrical power in accordance with the requested value can be supplied from each of the inverters 90 and 110 to the household appliance 66.

Further, in step S5, which will be discussed later, the connection/disconnection units 24 and 26 are switched to the disconnected state or the connected state in a comparatively short time period. Therefore, in the situation of the aforementioned case (1) and case (2), even if the phases of the two AC voltages output from the inverters 90 and 110 are shifted from the phase of the AC voltage supplied to the first electrical power source device 10 from the distribution board 48, the household appliance 66 may not recognize that a change has occurred in the AC voltage prior to and after switching taking place. In this case, in step S3, the ECU 22 may cause at least the AC voltage output from the inverter 90 and the AC voltage output from the inverter 110 to be synchronized.

In step S4, the ECU 22 determines whether or not the synchronization process has been completed. As noted previously, the detection results of the voltage sensors 40, 92, and 112 are sequentially input to the ECU 22. Accordingly, based on the detection results of the voltage sensors 40, 92, and 112, the ECU 22 determines whether or not the AC voltages are synchronized.

In the case that the AC voltages are not synchronized (step S4: NO), the ECU 22 continues the synchronization process of step S3. In the case that the AC voltages are synchronized (step S4: YES), the ECU 22 proceeds to step S5.

In step S5, the ECU 22, at first, switches the connection/disconnection unit 26 from the connected state to the disconnected state. As a result, the pass-through mode is ended, and the supply of the AC electrical power from the distribution board 48 to the household appliance 66 is stopped. Next, the ECU 22 switches the connection/disconnection unit 24 from the disconnected state to the connected state.

In accordance therewith, in step S6, the supply of the AC electrical power from the first conversion unit 18 and the second conversion unit 20 to the household appliance 66 is started. Since the ECU 22 electrically performs the switching control on the two connection/disconnection units 24 and 26, it is possible to switch the source that supplies the electrical power to the household appliance 66 in a short time period. In addition, the AC electrical power can be supplied to the household appliance 66 without causing an overlap in the AC electrical power from the distribution board 48, and the AC electrical power from the first conversion unit 18 and the second conversion unit 20. As a result, a fluctuation in the AC electrical power (the AC voltage) prior to and after switching taking place can be suppressed. More specifically, the household appliance 66 which serves as the load can recognize as if the AC power is continuously supplied from one electrical power source. Furthermore, since the connection/disconnection unit 24 is switched to the connected state after the connection/disconnection unit 26 has been switched to the disconnected state, the generation of a reverse power flow from the first electrical power source device 10 to the alternating current system 58 can be avoided. This eliminates the need for a monitoring mechanism to monitor the reverse power flow, and enables the first electrical power source device 10 to be configured at a low cost.

In this manner, the ECU 22 predicts the occurrence of the events of the aforementioned case (1) and case (2), and carries out the synchronization process in step S3. Consequently, even in the case that the requested value of the household appliance 66 which serves as the load changes, or the amplitude or the frequency of the AC voltage supplied to the household appliance 66 changes, a change in the AC electrical power supplied to the household appliance 66 can be suppressed.

Further, in the event of the aforementioned case (3), then in step S6, the ECU 22 may supply the AC electrical power from the first conversion unit 18 and the second conversion unit 20 all at once to the household appliance 66. Consequently, the household appliance 66 can rapidly be restored from the state of the power outage.

In the flowchart of FIG. 4, a change therein is possible as indicated by the dashed lines. In this operation, in step S1, the two connection/disconnection units 26 and 28 (refer to FIG. 2) are switched from the disconnected state to the connected state. Consequently, the AC electrical power supplied from the distribution board 48 (refer to FIG. 1) is output to the household appliance 66, the first conversion unit 18, and the second conversion unit 20. Each of the inverters 90 and 110 converts the AC electrical power to a DC electrical power. Each of the DC/DC converters 88 and 108 converts the DC voltage into a DC voltage of a desired value. Consequently, each of the first electrical power storage unit 14 and the second electrical power storage unit 16 is charged. In other words, while supplying the AC electrical power supplied from the distribution board 48, to the household appliance 66 by way of the pass-through mode, the first electrical power source device 10 charges the first electrical power storage unit 14 and the second electrical power storage unit 16 with a portion of the AC electrical power.

In the case that the determination result in step S2 has become affirmative (step S2: YES), the ECU 22 proceeds to step S7. In step S7, the ECU 22 switches the connection/disconnection unit 28 from the connected state to the disconnected state. Consequently, outputting of the AC electrical power from the distribution board 48 to the first conversion unit 18 and the second conversion unit 20 is stopped, and the process of charging the first electrical power storage unit 14 and the second electrical power storage unit 16 is ended. Thereafter, the ECU 22 executes the synchronization process of step S3. In this way, the synchronization process is executed after the charging process has come to an end. As a result, the synchronization process can be carried out reliably.

Further, according to the first embodiment, by detaching one of the first electrical power storage unit 14 or the second electrical power storage unit 16, it is also possible to supply the electrical power to a device other than the household appliance 66. As such a device, for example, there may be cited a vehicle such as a two-wheeled vehicle or the like, and a general-purpose device such as a lawn mower or the like.

In this case, the ECU 22 acquires beforehand scheduled consumption information or scheduled detachment information, and based on the acquired information, may calculate the amount of electrical power that is capable of being supplied (a suppliable electrical power) to the household appliance 66 from the first electrical power storage unit 14 and the second electrical power storage unit 16. The scheduled consumption information is information indicating that a device other than the household appliance 66 is made to consume the electrical power of the electrical power storage units. The scheduled detachment information is information indicating that there is a possibility that the first electrical power storage unit 14 or the second electrical power storage unit 16 is detached from the first electrical power source device 10.

In accordance with this feature, it is possible to avoid that the electrical power from the electrical power storage unit that serves as the object to be detached will be output to the household appliance 66. Moreover, by the ECU 22 stopping the operation of the conversion unit that is connected to the electrical power storage unit that is the object to be detached, it is possible to avoid outputting, to the household appliance 66, the electrical power from the electrical power storage unit that is the object to be detached.

Furthermore, according to the first embodiment, the first electrical power source device 10 and the second electrical power source device 130 (see FIG. 3) are electrically connected via the wires 178 and 180. Further, the first electrical power source device 10 and the second electrical power source device 130 are capable of transmitting and receiving signals or information via the communication units 36, 38, 156, and 158. Therefore, according to the first embodiment, in step S3, the AC voltages output respectively from the first conversion unit 18, the second conversion unit 20, the third conversion unit 138, and the fourth conversion unit 140 may be synchronized. Consequently, in step S6, the AC electrical power can be supplied to the household appliance 66 from the first conversion unit 18, the second conversion unit 20, the third conversion unit 138, and the fourth conversion unit 140.

Further still, according to the first embodiment, in the synchronization process of step S3, the ECU 22 may cause the AC voltages output respectively from the first conversion unit 18 and the second conversion unit 20 to be synchronized at a zero-cross point. More specifically, the ECU 22 controls the first conversion unit 18 and the second conversion unit 20, in a manner so that one of the AC voltages is output from the zero-cross point of the other of the AC voltages.

Further, in the synchronization process of step S3, each of the ECUs 22 and 142 may synchronize, at a zero-cross point, the AC voltages output respectively from the first conversion unit 18, the second conversion unit 20, the third conversion unit 138, and the fourth conversion unit 140. In this case, each of the ECUs 22 and 142 may control the first conversion unit 18, the second conversion unit 20, the third conversion unit 138, and the fourth conversion unit 140, in a manner so that the remaining three AC voltages are output from the zero-cross point of one AC voltage.

Alternatively, as shown in FIG. 5, in the case that the AC voltage is output in the order of the first conversion unit 18 (refer to FIG. 2), the second conversion unit 20, the third conversion unit 138 (refer to FIG. 3), and the fourth conversion unit 140, the AC voltage may be sequentially output at intervals of one cycle from the zero-cross point of the AC voltage that was previously output. In FIG. 5, the period of each of the AC voltages is represented by T, and the amplitude is represented by Vm. In this case, an AC voltage is output at time point to from the first conversion unit 18. Further, at time point t1, after the period T has elapsed from time point to, an AC voltage is output from the second conversion unit 20. Time point t1 is also the zero-cross point of the AC voltage output from the first conversion unit 18. Further, at time point t2, after the period T has elapsed from time point t1, an AC voltage is output from the third conversion unit 138. Time point t2 is also the zero-cross point of the AC voltage output from the second conversion unit 20. Further still, at time point t3, after the period T has elapsed from time point t2, an AC voltage is output from the fourth conversion unit 140. Time point t3 is also the zero-cross point of the AC voltage output from the third conversion unit 138. In the case that there is a malfunction in supplying the AC electrical power to the household appliance 66 (refer to FIG. 1), it becomes possible to appropriately deal with such a malfunction by sequentially outputting the AC voltages in this manner.

Moreover, in the case of outputting the AC voltages from the first conversion unit 18, the second conversion unit 20, the third conversion unit 138, and the fourth conversion unit 140, the AC voltages may be output at the same time point. In accordance with this feature, the household appliance 66 can be rapidly restored from the state of the power outage.

Further, according to the first embodiment, the first electrical power source device 10 may supply, to the household appliance 66, both the AC electrical power supplied from the distribution board 48, and the AC electrical power supplied from the first conversion unit 18 and the second conversion unit 20. In accordance with this feature, it becomes possible to compensate for an insufficiency in the electrical power supplied by the pass-through mode, with the electrical power supplied from the first electrical power storage unit 14 and the second electrical power storage unit 16.

Further, according to the first embodiment, the ECU 22 may obtain an estimated value of the AC electrical power based on the detection results of the voltage sensors 40, 92, and 112 and the electrical current sensors 42, 94, and 114. Consequently, using the estimated value of the AC electrical power, the ECU 22 is capable of performing the processes of steps S2 to S4.

Further, according to the first embodiment, at a time when it can be predicted (estimated) that the state quantities that serve as objects to be determined will coincide with each other in a short time period, then in step S4, the ECU 22 may determine that the synchronization process has been completed. In accordance with this feature, the ECU 22 can execute the process of step S5 at a stage in which it can be estimated that the state quantities that serve as objects to be determined will coincide with each other.

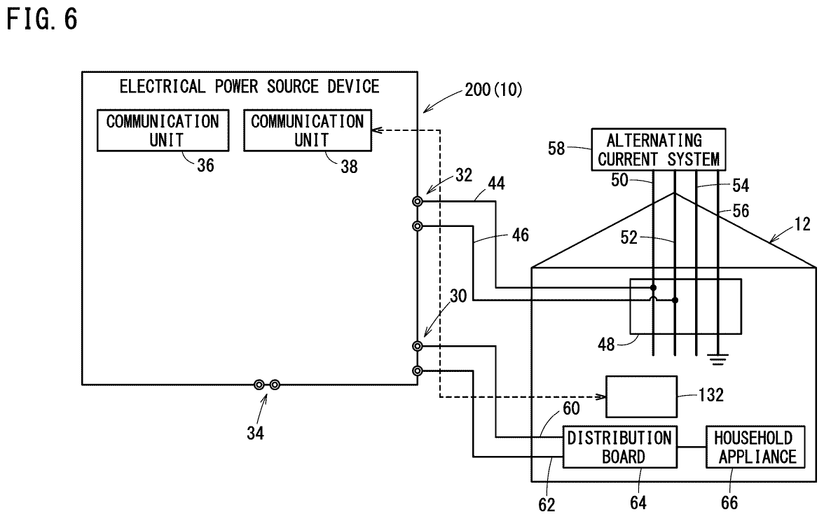

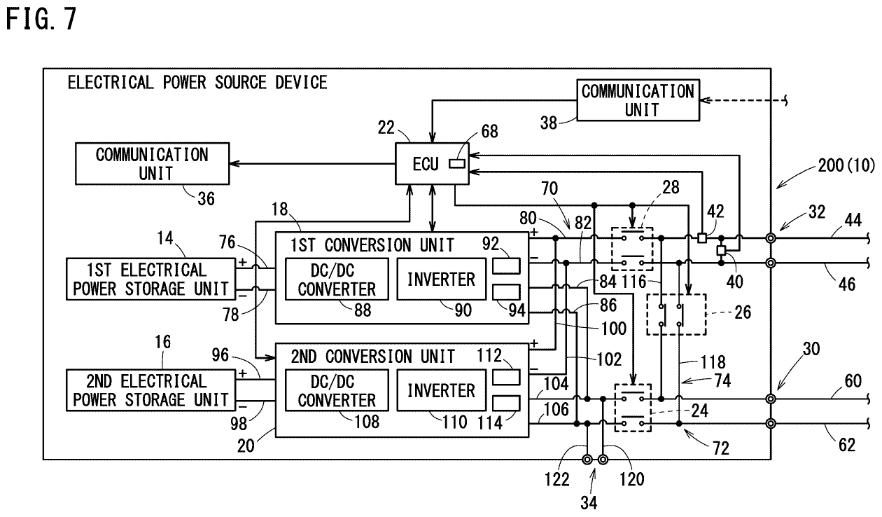

A description will be given with reference to FIG. 6 and FIG. 7 concerning an electrical power source device 200 according to a second embodiment. The electrical power source device 200 according to the second embodiment differs from the electrical power source device 10 (the first electrical power source device 10 [refer to FIG. 1]) according to the first embodiment, in that the second electrical power source device 130 is not connected thereto. Accordingly, the electrical power source device 200 according to the second embodiment has the same configuration as the first electrical power source device 10. The electrical power source device 200 according to the second embodiment is capable of operating in the same manner as the first electrical power source device 10. Accordingly, with the electrical power source device 200 according to the second embodiment as well, the same effects as those of the first electrical power source device 10 can be obtained.

Moreover, in the first embodiment and the second embodiment, in the case that the first electrical power storage unit 14 or the second electrical power storage unit 16 is detached from the electrical power source device 10 or 200, the first electrical power storage unit 14 or the second electrical power storage unit 16 can be used as a power source for various types of vehicles, such as a one-wheeled vehicle, a two-wheeled vehicle, a three-wheeled vehicle, a four-wheeled vehicle, or the like. As such vehicles, there may be cited electric vehicles and vehicles equipped with a drive motor such as hybrid vehicles.

Further, the first electrical power storage unit 14 or the second electrical power storage unit 16 can be used as an electrical power source for various types of mobile bodies. Mobile bodies on which people are capable of riding, or alternatively, mobile bodies on which people are incapable of riding are included in the various types of mobile bodies. As the mobile bodies of such a type, in addition to vehicles, there may be cited aircraft, flying objects, ships, and the like.

Further, the first electrical power storage unit 14 or the second electrical power storage unit 16 can be used as an electrical power source for the following general-purpose devices. Specifically, as the various types of general-purpose devices, there may be cited (1) various discharging devices, and (2) various working machines such as general-purpose working machines, lawn mowers, tillers, and blowers or the like. Further, as the various types of general-purpose devices, there may be cited (3) electrical devices in which electric motors are not included, such as floodlights and lighting devices or the like, and (4) various devices installed in residential dwellings, buildings, or the like.

Concerning items (1) through (4), such devices may be general-purpose devices that do not have a person riding thereon. Further, concerning item (2), the working machine may be a working machine that does not have a person riding thereon. Alternatively, concerning item (2), the working machine may be a working machine that has a person riding thereon. Furthermore, as examples of the aforementioned item (4), there may be cited (A) equipment that operates with the DC electrical power, as in audio equipment such as clocks and radio cassette recorders and the like, and (B) equipment that operates with the AC electrical power such as electric fans, juicers, mixers, or alternatively, incandescent electric lamps or the like. Further, as other examples of the aforementioned item (4), there may be cited (C) equipment that operates with the DC electrical power that is converted from the AC electrical power, such as televisions, radios, stereos, personal computers or the like. Furthermore, as other examples of the aforementioned item (4), there may be cited (D) inverter type equipment including washing machines, refrigerators, air conditioners, microwave ovens, and fluorescent lamps. The equipment of the aforementioned item (D) is equipment that operates with the AC electrical power, which after having been temporarily converted from the AC electrical power to the DC electrical power, is then further converted from the DC electrical power.

Furthermore, in the description provided above, a description has been given concerning a case in which the electrical power source devices 10 and 200 include the first electrical power storage unit 14 and the second electrical power storage unit 16. The electrical power source devices 10 and 200 may include three or more electrical power storage units.

The electrical power source devices 10 and 200 are capable of being applied to various electrical power source systems that supply electrical power to a load or the like from the plurality of electrical power storage units, or alternatively, that charge the plurality of electrical power storage units. The electrical power source devices 10 and 200 are capable of being installed not only in the residential dwelling 12, but also in various business offices, public facilities, or the like.

The electrical power source devices 10 and 200 are also capable of being applied to electrical power source systems of various types of mobile bodies. Examples of the various types of mobile bodies include the aforementioned mobile bodies. Further, the electrical power source device 10 is also capable of being applied to electrical power source systems of the aforementioned various types of general-purpose devices.

Further, in the description provided above, although a description has been given concerning a case in which the operating unit is the household appliance 66, the operating unit may be another electrical power consuming device that operates with the AC electrical power.

Further, in the description provided above, a description has been given concerning a case in which the ECU 22 determines to carry out switching of the connection/disconnection unit 24 from the disconnected state to the connected state. According to the present embodiment, the ECU 22 may acquire the content of the determination of carrying out switching from the disconnected state to the connected state, and in accordance with the acquired content of the determination, may carry out switching of the connection/disconnection unit 24 from the disconnected state to the connected state.

Concerning the inventions that are capable of being grasped from the above-described embodiments, descriptions thereof will be given below.

The first aspect of the present invention is the electrical power source device (10, 200) equipped with the electrical power storage unit (14, 16), the external connection unit (30) connected to the operating unit (66) provided externally, and the connection/disconnection unit (24) arranged on the electrical power transmission pathway (72) located between the electrical power storage unit and the external connection unit, wherein the electrical power storage unit includes the first electrical power storage unit (14) and the second electrical power storage unit (16) that are arranged in parallel with each other, the electrical power source device comprises the first electrical power conversion unit (18, 90) disposed in the electrical power transmission pathway located between the first electrical power storage unit and the connection/disconnection unit, the second electrical power conversion unit (20, 110) disposed in the electrical power transmission pathway located between the second electrical power storage unit and the connection/disconnection unit, and the control unit (22) that controls the first electrical power conversion unit and the second electrical power conversion unit, the first electrical power conversion unit converts the DC electrical power supplied from the first electrical power storage unit into the AC electrical power, and the second electrical power conversion unit converts the DC electrical power supplied from the second electrical power storage unit into the AC electrical power, wherein at a time when the connection/disconnection unit switches from the disconnected state to the connected state, the control unit controls the first electrical power conversion unit and the second electrical power conversion unit to perform a control so that the first state quantities correlated with the frequencies of the AC voltages output from the first electrical power conversion unit and the second electrical power conversion unit are made to coincide with each other, and further, the second state quantities correlated with the phases of the AC voltages are made to coincide with each other.

According to the present invention, when the source that supplies the electrical power to the operating unit is switched, prior to and after switching taking place, a change in the electrical power supplied to the operating unit can be suppressed.

In the first aspect of the present invention, at the time when the connection/disconnection unit is switched from the disconnected state to the connected state, the control unit controls the first electrical power conversion unit and the second electrical power conversion unit to perform a control so that the third state quantities correlated with the amplitudes of the AC voltages output from the first electrical power conversion unit and the second electrical power conversion unit are made to coincide with each other.

In accordance with this feature, at the time when the source that supplies the electrical power to the operating unit is switched, prior to and after switching taking place, a change in the electrical power supplied to the operating unit can be further suppressed.

In the first aspect of the present invention, the electrical power source device further comprises the first control unit (22), which is the control unit, and the second control unit (22) that controls the connection/disconnection unit, wherein, at the time when it is acquired that the first control unit has caused the first state quantities of the AC voltages output from the first electrical power conversion unit and the second electrical power conversion unit to coincide with each other, and further, has caused the second state quantities of the AC voltages to coincide with each other, the second control unit switches the connection/disconnection unit from the disconnected state to the connected state.

In accordance with this feature, since the phase of the waveform of the AC voltage prior to switching, and the phase of the waveform of the AC voltage after switching coincide with each other, a change in the AC voltage prior to and after switching taking place can be suppressed reliably and efficiently.

In the first aspect of the present invention, the electrical power source device further comprises the first external connection unit (30), which is the external connection unit, the second external connection unit (32) connected to the AC electrical power source (58) provided externally, and the connection path (74) that connects the first external connection unit and the second external connection unit.

In accordance with this feature, either one of the AC electrical power from the AC electrical power source, or the AC electrical power from the first conversion unit and the second conversion unit can be supplied to the operating unit.

In the first aspect of the present invention, the electrical power source device further comprises the third control unit (22), which is the control unit, the first connection/disconnection unit (24), which is the connection/disconnection unit, the second connection/disconnection unit (26) arranged in the connection path, and the fourth control unit (22) that controls the second connection/disconnection unit, wherein, in the case that the first connection/disconnection unit is in the disconnected state, and further, the second connection/disconnection unit is in the connected state, the fourth control unit switches the second connection/disconnection unit from the connected state to the disconnected state, prior to the first connection/disconnection unit being switched from the disconnected state to the connected state.

In accordance with this feature, it is possible to prevent the occurrence of a time period in which the electrical power transmission pathway and the connection path become placed in a connected state. As a result, generation of a reverse power flow from the first electrical power storage unit and the second electrical power storage unit to the AC electrical power source can be reliably prevented.

In the first aspect of the present invention, at a time when the connection/disconnection unit switches from the disconnected state to the connected state in a state in which the external AC voltage is being supplied from the AC electrical power source to the connection path, the control unit controls the first electrical power conversion unit and the second electrical power conversion unit to perform a control so that the fourth state quantity correlated with the frequency of the external AC voltage is made to coincide with the first state quantities, and further, the fifth state quantity correlated with the phase of the external AC voltage is made to coincide with the second state quantities.

In accordance with this feature, since the phase of the external AC voltage prior to switching, and the phase of the AC voltage after switching coincide with each other, a change in the AC voltage prior to and after switching taking place can be further suppressed.

In the first aspect of the present invention, the electrical power source device further comprises the fifth control unit (22), which is the control unit, the sixth control unit (22) that controls the connection/disconnection unit, and the first electrical power acquisition unit (22, 40, 42) that acquires the output electrical power supplied to the operating unit via the first external connection unit, and the input electrical power supplied from the AC electrical power source to the connection path via the second external connection unit, wherein the sixth control unit controls the connection/disconnection unit based on the output electrical power and the input electrical power acquired by the first electrical power acquisition unit.

In accordance with this feature, the connection/disconnection unit can be switched with high accuracy from the disconnected state to the connected state.

In the first aspect of the present invention, in the case that the connection/disconnection unit is in the disconnected state, at a time when it is acquired that the input electrical power has become smaller than the output electrical power, or alternatively, that the input electrical power will become smaller than the output electrical power, the sixth control unit switches the connection/disconnection unit from the disconnected state to the connected state.

In accordance with this feature, it is possible to avoid an insufficiency in the output electrical power supplied to the operating unit. As a result, a change in the AC electrical power prior to and after switching taking place can be further suppressed.

In the first aspect of the present invention, when the connection path is the first connection path (74), the electrical power source device further comprises the second connection path (70) that connects the second external connection unit and the electrical power storage unit.

In accordance with this feature, the electrical power storage unit is capable of being charged while the AC electrical power is supplied to the operating unit.

In the first aspect of the present invention, the electrical power source device further comprises the seventh control unit (22), which is the control unit, the third connection/disconnection unit (24), which is the connection/disconnection unit, the fourth connection/disconnection unit (28) arranged in the second connection path, and the eighth control unit (22) that controls the fourth connection/disconnection unit, wherein, prior to the seventh control unit performing the control so that the first state quantities of the AC voltages output from the first electrical power conversion unit and the second electrical power conversion unit are made to coincide with each other, and further, the second state quantities of the AC voltages are made to coincide with each other, the eighth control unit switches the fourth connection/disconnection unit from the connected state to the disconnected state.

It is not possible to perform the process of causing the first state quantities to coincide with each other and the second state quantities to coincide with each other while charging the electrical power storage unit. Thus, by switching the fourth connection/disconnection unit to the disconnected state prior to carrying out the process of causing the first state quantities to coincide with each other and the second state quantities to coincide with each other, it is possible to reliably cause the first state quantities to coincide with each other and the second state quantities to coincide with each other.

In the first aspect of the present invention, the electrical power source device further comprises the ninth control unit (22), which is the control unit, the tenth control unit (22) that controls the connection/disconnection unit, and the second electrical power acquisition unit (22, 92, 94, 112, 114) that acquires the suppliable electrical power, which is the electrical power that is capable of being supplied to the external connection unit from the first electrical power storage unit and the second electrical power storage unit, wherein the tenth control unit controls the connection/disconnection unit based on the suppliable electrical power.

In accordance with this feature, it is possible to avoid an insufficiency in the electrical power supplied to the operating unit.

In the first aspect of the present invention, the second electrical power acquisition unit acquires the suppliable electrical power, based on the scheduled consumption information indicating that the electrical power of the first electrical power storage unit or the second electrical power storage unit will be consumed for a purpose other than being supplied to the external connection unit.

In accordance with this feature, it is possible to avoid outputting the electrical power to the operating unit from the electrical power storage unit that will supply the electrical power to a device other than the operating unit. As a result, the electrical power can be supplied to such a device. Further, it is also possible to avoid an insufficiency in the electrical power supplied to the operating unit.

In the first aspect of the present invention, the first electrical power storage unit and the second electrical power storage unit are capable of being attached to and detached from the electrical power source device.

In accordance with this feature, the first electrical power storage unit or the second electrical power storage unit can be used as an electrical power source for the purpose of supplying electrical power to a device other than the operating unit.

In the first aspect of the present invention, the second electrical power acquisition unit acquires the suppliable electrical power, based on the scheduled detachment information indicating that there is a possibility that the first electrical power storage unit or the second electrical power storage unit is detached from the electrical power source device.

In accordance with this feature, it is possible to avoid outputting the electrical power to the operating unit from the electrical power storage unit that will supply the electrical power to a device other than the operating unit. As a result, the electrical power can be supplied to such a device. Further, it is also possible to avoid an insufficiency in the electrical power supplied to the operating unit.

In the first aspect of the present invention, the electrical power source device further comprises the third external connection unit (30), which is the external connection unit, and the fourth external connection unit (34) connected to the other electrical power source device (130) provided externally.

In accordance with this feature, the AC electrical power from the other electrical power source device can be supplied to the operating unit.

In the first aspect of the present invention, the electrical power source device further comprises the communication unit (36, 38) that is capable of communicating with the other electrical power source device, wherein the other electrical power source device comprises the other electrical power storage unit (134, 136), the other electrical power conversion unit (138, 140, 166) that converts the DC electrical power output from the other electrical power storage unit into the AC electrical power, and the other control unit (142) that controls the other electrical power conversion unit, and further, is capable of communicating with the communication unit.

In accordance with this feature, the AC electrical power can be reliably supplied to the operating unit from the other electrical power source device.

In the first aspect of the present invention, the fourth external connection unit is connected to the electrical power transmission pathway located between the first electrical power conversion unit and the second electrical power conversion unit, and the connection/disconnection unit, and further, is connected to the other electrical power conversion unit.

In accordance with this feature, the AC electrical power supplied from the other electrical power source device can be reliably supplied to the operating unit via the electrical power source device of the present invention.

The second aspect of the present invention is the method of controlling the electrical power source device equipped with the electrical power storage unit, the external connection unit connected to the operating unit provided externally, and the connection/disconnection unit arranged on the electrical power transmission pathway located between the electrical power storage unit and the external connection unit, wherein the electrical power storage unit includes the first electrical power storage unit and the second electrical power storage unit that are arranged in parallel with each other, the electrical power source device comprises the first electrical power conversion unit disposed in the electrical power transmission pathway located between the first electrical power storage unit and the connection/disconnection unit, and the second electrical power conversion unit disposed in the electrical power transmission pathway located between the second electrical power storage unit and the connection/disconnection unit, the first electrical power conversion unit converts the DC electrical power supplied from the first electrical power storage unit into the AC electrical power, and the second electrical power conversion unit converts the DC electrical power supplied from the second electrical power storage unit into the AC electrical power, the method of controlling comprising the first step of determining or acquiring switching of the connection/disconnection unit from the disconnected state to the connected state, the second step of performing a control so that the first state quantities correlated with the frequencies of the AC voltages output from the first electrical power conversion unit and the second electrical power conversion unit are made to coincide with each other, and further, the second state quantities correlated with the phases of the AC voltages are made to coincide with each other, the third step of switching the connection/disconnection unit from the disconnected state to the connected state, and the fourth step of starting to supply the AC electrical power from each of the first electrical power conversion unit and the second electrical power conversion unit to the operating unit.

In the present invention as well, at the time when the source that supplies the electrical power to the operating unit is switched, prior to and after switching taking place, a change in the electrical power supplied to the operating unit can be suppressed.

The third aspect of the present invention is the program that causes the computer (22) to execute the method of controlling the electrical power source device according to the second aspect.

In the present invention as well, at the time when the source that supplies the electrical power to the operating unit is switched, prior to and after switching taking place, a change in the electrical power supplied to the operating unit can be suppressed.

The fourth aspect of the present invention is the storage medium (68) that stores the program according to the third aspect.

In the present invention as well, at the time when the source that supplies the electrical power to the operating unit is switched, prior to and after switching taking place, a change in the electrical power supplied to the operating unit can be suppressed.

Moreover, it should be noted that the present invention is not limited to the disclosure described above, but various configurations may be adopted therein without departing from the essence and gist of the present invention.

1. An electrical power source device equipped with an electrical power storage unit, an external connection unit connected to an operating unit provided externally, and a connection/disconnection unit arranged on an electrical power transmission pathway located between the electrical power storage unit and the external connection unit,
wherein the electrical power storage unit includes a first electrical power storage unit and a second electrical power storage unit that are arranged in parallel with each other,
the electrical power source device comprises a first electrical power conversion unit disposed in the electrical power transmission pathway located between the first electrical power storage unit and the connection/disconnection unit, a second electrical power conversion unit disposed in the electrical power transmission pathway located between the second electrical power storage unit and the connection/disconnection unit, and a computer configured to control the first electrical power conversion unit and the second electrical power conversion unit,
the first electrical power conversion unit converts a direct current electrical power supplied from the first electrical power storage unit into an alternating current electrical power,
the second electrical power conversion unit converts a direct current electrical power supplied from the second electrical power storage unit into an alternating current electrical power, and
at a time when the connection/disconnection unit switches from a disconnected state to a connected state, the computer executes a program stored in a memory to control the first electrical power conversion unit and the second electrical power conversion unit to perform a control so that first state quantities correlated with frequencies of alternating current voltages output from the first electrical power conversion unit and the second electrical power conversion unit are made to coincide with each other, and further, second state quantities correlated with phases of the alternating current voltages are made to coincide with each other.

2. The electrical power source device according to claim 1, wherein
at a time when the connection/disconnection unit is switched from the disconnected state to the connected state, the computer controls the first electrical power conversion unit and the second electrical power conversion unit to perform a control so that third state quantities correlated with amplitudes of the alternating current voltages output from the first electrical power conversion unit and the second electrical power conversion unit are made to coincide with each other.

3. The electrical power source device according to claim 1,
wherein the computer further controls the connection/disconnection unit, and
at a time when it is acquired that the first state quantities of the alternating current voltages output from the first electrical power conversion unit and the second electrical power conversion unit have been made to coincide with each other, and further, the second state quantities of the alternating current voltages have been made to coincide with each other, the computer switches the connection/disconnection unit from the disconnected state to the connected state.

4. The electrical power source device according to claim 1, further comprising a first external connection unit, which is the external connection unit, a second external connection unit connected to an alternating current electrical power source provided externally, and a connection path configured to connect the first external connection unit and the second external connection unit.

5. The electrical power source device according to claim 4, further comprising a first connection/disconnection unit, which is the connection/disconnection unit, and a second connection/disconnection unit arranged in the connection path,
wherein the computer further controls the second connection/disconnection unit, and
in a case that the first connection/disconnection unit is in the disconnected state, and further, the second connection/disconnection unit is in the connected state, the computer switches the second connection/disconnection unit from the connected state to the disconnected state, prior to the first connection/disconnection unit being switched from the disconnected state to the connected state.

6. The electrical power source device according to claim 4, wherein
at a time when the connection/disconnection unit switches from the disconnected state to the connected state in a state in which an external alternating current voltage is being supplied from the alternating current electrical power source to the connection path, the computer controls the first electrical power conversion unit and the second electrical power conversion unit to perform a control so that a fourth state quantity correlated with a frequency of the external alternating current voltage is made to coincide with the first state quantities, and further, a fifth state quantity correlated with a phase of the external alternating current voltage is made to coincide with the second state quantities.

7. The electrical power source device according to claim 4,
wherein the computer acquires an output electrical power supplied to the operating unit via the first external connection unit, and an input electrical power supplied from the alternating current electrical power source to the connection path via the second external connection unit, and
the computer controls the connection/disconnection unit based on the output electrical power and the input electrical power that have been acquired.

8. The electrical power source device according to claim 7, wherein
in a case that the connection/disconnection unit is in the disconnected state, at a time when it is acquired that the input electrical power has become smaller than the output electrical power, or alternatively, that the input electrical power will become smaller than the output electrical power, the computer switches the connection/disconnection unit from the disconnected state to the connected state.

9. The electrical power source device according to claim 4, further comprising, when the connection path is a first connection path, a second connection path configured to connect the second external connection unit and the electrical power storage unit.

10. The electrical power source device according to claim 9, further comprising a third connection/disconnection unit, which is the connection/disconnection unit, a fourth connection/disconnection unit arranged in the second connection path,
wherein, prior to performing the control so that the first state quantities of the alternating current voltages output from the first electrical power conversion unit and the second electrical power conversion unit are made to coincide with each other, and further, the second state quantities of the alternating current voltages are made to coincide with each other, the computer switches the fourth connection/disconnection unit from the connected state to the disconnected state.

11. The electrical power source device according to claim 1,
wherein the computer acquires a suppliable electrical power, which is an electrical power that is suppliable to the external connection unit from the first electrical power storage unit and the second electrical power storage unit, and
the computer controls the connection/disconnection unit based on the suppliable electrical power that has been acquired.

12. The electrical power source device according to claim 11, wherein
the computer acquires the suppliable electrical power, based on scheduled consumption information indicating that the electrical power of the first electrical power storage unit or the second electrical power storage unit will be consumed for a purpose other than being supplied to the external connection unit.

13. The electrical power source device according to claim 11, wherein
the first electrical power storage unit and the second electrical power storage unit are attachable to and detachable from the electrical power source device.

14. The electrical power source device according to claim 13, wherein
the computer acquires the suppliable electrical power, based on scheduled detachment information indicating that there is a possibility that the first electrical power storage unit or the second electrical power storage unit is detached from the electrical power source device.

15. The electrical power source device according to claim 1, further comprising a third external connection unit, which is the external connection unit, and a fourth external connection unit connected to another electrical power source device provided externally.

16. The electrical power source device according to claim 15, further comprising a communication unit configured to communicate with the other electrical power source device,
wherein the other electrical power source device comprises another electrical power storage unit, another electrical power conversion unit configured to convert a direct current electrical power output from the other electrical power storage unit into an alternating current electrical power, and computer configured to control the other electrical power conversion unit and configured to communicate with the communication unit, and
the other computer is configured to control the other electrical power conversion unit and configured to communicate with the communication unit by executing a program stored in another memory.

17. The electrical power source device according to claim 16, wherein
the fourth external connection unit is connected to the electrical power transmission pathway located between the first electrical power conversion unit and the second electrical power conversion unit, and the connection/disconnection unit, and further, is connected to the other electrical power conversion unit.

18. A method of controlling an electrical power source device equipped with an electrical power storage unit, an external connection unit connected to an operating unit provided externally, and a connection/disconnection unit arranged on an electrical power transmission pathway located between the electrical power storage unit and the external connection unit,
wherein the electrical power storage unit includes a first electrical power storage unit and a second electrical power storage unit that are arranged in parallel with each other,
the electrical power source device comprises a first electrical power conversion unit disposed in the electrical power transmission pathway located between the first electrical power storage unit and the connection/disconnection unit, and a second electrical power conversion unit disposed in the electrical power transmission pathway located between the second electrical power storage unit and the connection/disconnection unit,
the first electrical power conversion unit converts a direct current electrical power supplied from the first electrical power storage unit into an alternating current electrical power, and
the second electrical power conversion unit converts a direct current electrical power supplied from the second electrical power storage unit into an alternating current electrical power,
the method of controlling comprising, by a computer executing a program stored in a memory:
determining or acquiring switching of the connection/disconnection unit from a disconnected state to a connected state;
performing a control so that first state quantities correlated with frequencies of alternating current voltages output from the first electrical power conversion unit and the second electrical power conversion unit are made to coincide with each other, and further, second state quantities correlated with phases of the alternating current voltages are made to coincide with each other;
switching the connection/disconnection unit from the disconnected state to the connected state; and
starting to supply the alternating current electrical power from each of the first electrical power conversion unit and the second electrical power conversion unit to the operating unit.

19. (canceled)

20. A storage medium configured to store a program configured to cause a computer to execute the method of controlling the electrical power source device according to claim 18.
